(19) United States
(12) Patent Application Publication
(10) Pub. No.: US 2006/0099408 A1
(43) Pub. Date: May 11, 2006

(54) Pigment composition

(75) Inventors: Kjell Rune Andersson, Goteborg (SE); Joakim Carlen, Goteborg (SE); Erik Lindgren, Bohus (SE)

Correspondence Address: AKZO NOBEL INC.;INTELLECTUAL PROPERTY DEPARTMENT, 7 LIVINGSTONE AVENUE, DOBBS FERRY, NY, 10522-3408, US

(73) Assignee: AKZO NOBEL N.V., Arnhem (NL)

(21) Appl. No.: 11/267,758

(22) Filed: Nov. 3, 2005

Related U.S. Application Data
(60) Provisional application No. 60/629,810, filed on Nov. 9, 2004.

(30) Foreign Application Priority Data
Nov. 8, 2004 (EP) 04105595.5

(51) Int. Cl. B32B 5/16; B05D 3/02

(52) U.S. Cl. 428/331; 428/342; 428/537.5; 427/391; 427/397.7

(57) ABSTRACT

The present invention relates to a process for the production of coated paper or paperboard comprising a step of applying a pigment composition as a coating to at least one side of a paper or paperboard web, said pigment composition being an aqueous dispersion comprising as pigment particles optionally aggregated colloidal particles of silica or aluminosilicate prepared from alkali metal silicate by ion exchange or pH-reduction and having a surface area from about 30 m²/g to about 450 m²/g, and at least one cationic component selected from the group consisting of water soluble aluminium salts and cationic polymers with a molecular weight from about 2000 to about 1000000 and a charge density from about 0.2 meq/g to about 12 meq/g, wherein at least about 0.4 g pigment particles from the pigment composition are applied per m² coated side of the paper or paper board web.

This application claims priority based on European Patent Application No. 04105595.5, filed on Nov. 8, 2004 and on U.S. Provisional Patent Application No. 60/629,810, filed Nov. 9, 2004.

The present invention relates to a process for the production of coated paper or paperboard pigment, paper or paper board obtainable by the process, a novel pigment composition useful therefore and a process for its production.

### BACKGROUND OF THE INVENTION

The development of ink-jet printers has led to a demand for paper that is suitable for that purpose. Particularly, there is a demand for paper that is simple to produce but still enables ink-jet printing of high quality.

It has been disclosed to use various kinds of coatings to produce paper suitable for ink-jet printing.

US Patent Application Publication 2002/0039639 discloses incorporating a water soluble metal salt in an ink receiving layer comprising pigments and a conventional binder.

U.S. Pat. No. 4,554,181 discloses a recording surface including a combination of a water soluble polyvalent metal and a cationic polymer.

US Patent Application Publication 2004/0255820 discloses a pigment that is surface treated with a water-soluble polyvalent metal salt.

US Patent Application Publication 2005/0106317 discloses a method for preparing an ink-jet recording material comprising the steps of forming at least one porous layer containing silica particles with an average secondary particle size of 500 nm or less, and coating a coating solution for preparing an inorganic particles-containing layer so that a solid content of the coated inorganic particles became 0.33 g/m² or less on the porous layer.

U.S. Pat. No. 6,797,347 discloses an ink-jet paper comprising a base paper and a coating thereon, wherein said coating contains an inorganic pigment modified with a positively charged complex and a binder. The positively charged complex contains a polyvalent metal ion and an organic ligand.

US Patent Application Publication 2003/0099816 discloses an ink jet-recording material comprising a substrate and a transparent ink-receiving layer comprising a binder and a plurality of particles formed by dispersing amorphous silica particles and applying a strong mechanical stress to divide the particles.

Other examples of disclosures relating to coated paper are WO 03/011981, WO 01/53107, WO 01/45956, EP 947349, EP 1120281 EP 1106373 and U.S. Pat. No. 5,551,975.

It is an object of the invention to provide a pigment composition suitable for coating paper or paper board for ink-jet printing and that is simple to produce.

It is another object of the invention to provide a coating formulation that is simple to apply on the surface of paper or paper board to make it suitable for ink-jet printing.

It is still another object of the invention to provide a paper or paper board suitable for ink-jet printing that is simple to produce.

### SUMMARY OF THE INVENTION

It has been found that the objects can be achieved by the present invention, one aspect of which concerns a process for the production of coated paper or paperboard comprising a step of applying a pigment composition as a coating to at least one side of a paper or paperboard web, said pigment composition being an aqueous dispersion comprising as pigment particles optionally aggregated colloidal particles of silica or aluminosilicate prepared from alkali metal silicate by ion exchange or pH-reduction and having a surface area from about 30 m²/g to about 450 m²/g, and at least one cationic component selected from the group consisting of water soluble aluminium salts and cationic polymers with a molecular weight from about 2000 to about 1000000 and a charge density from about 0.2 meq/g to about 12 meq/g, wherein at least about 0.4 g pigment particles from the pigment composition are applied per m² coated side of the paper or paper board web.

### DETAILED DESCRIPTION OF THE INVENTION

It has surprisingly been found that good results are achieved with no or only very small amounts of binders conventionally used in paper coating. It is thus preferred that the pigment composition applied to the paper or paper board is substantially free from or comprises, based on the total amount of pigment particles, less than about 3 wt %, preferably less than about 2 wt %, most preferably less than about 1 wt % of organic coating binders. Such binders include polyvinyl alcohols, optionally modified starches, gums, protein binders (e.g. caseins and soy protein binders), latices and mixtures thereof. Latices can, for example, be based on styrene butadien, acrylates, vinyl acetate, copolymers of ethylene and vinyl acetates, styrene acrylic esters etc.

The pigment particles of optionally aggregated colloidal particles of silica or aluminosilicate preferably have a mean diameter from about 0.005 μm to about 25 μm, more preferably from about 0.007 μm to about 15 μm, most preferably from about 0.01 μm to about 10 μm. The particles preferably have a surface area from about 40 m²/g to about 400 m²/g particularly most preferably from about 50 m²/g to about 300 m²/g. The net surface charge of the pigment particles in the composition is preferably positive, the dispersion thus being regarded as predominantly cationic.

The term diameter as used herein refers to the equivalent spherical diameter.

Preferred pigment particles are colloidal primary particles of silica, aluminosilicate or a mixture thereof, or porous aggregates formed by aggregation of colloidal primary particles of silica, aluminosilicate or a mixture thereof in an aqueous sol, or a mixture of the above kinds of particles.

Colloidal primary particles of silica or aluminosilicate have preferably been formed from an aqueous solution of alkali metal silicate where alkali metal ions are removed through an ion exchange process or where the pH of the alkali metal silicate solution has been reduced by the addition of an acid. A process based on ion exchange follows the basic principles described in R. K. Iler, “The Chemistry of Silica” 1979, pages 333-334 and results in an aqueous sol comprising colloidal negatively or positively charged particles of silica or aluminosilicate. A process based on pH-reduction of alkali metal silicate follows the basic principles described in e.g. U.S. Pat. Nos. 5,176,891, 5,648,055, 5,853,616, 5,482,693, 6,060,523 and 6,274,112.

Particularly preferred sols comprise colloidal primary particles of silica that may or may not be surface modified, for example with a metal oxide such as oxide of aluminium, titanium, chromium, zirconium, boron or any other suitable metal.

The surface area of the primary particles is from about 30 m²/g to about 450 m²/g, preferably from about 40 m²/g to about 400 m²/g most preferably from about 50 m²/g to about 300 m²/g. The dry content of the aqueous sol of primary particles is preferably from about 0.5 wt % to about 60 wt %, most preferably from about 1 wt % to about 50 wt %.

Suitable aqueous sols of colloidal primary particles of silica or aluminosilicate are commercially available, for example under the trademarks Ludox™, Snowtex™, Bindzil™, Nyacol™, Vinnsil™ or Fennosil™.

Unlike a sol formed by dispersing a powder, the colloidal particles in a sol prepared from alkali metal silicate by ion exchange or pH-reduction have never been dried to a powder, such as in the case for e.g. precipitated silica, gel-type silica or fumed silica.

In the case the particles in the composition are aggregates of colloidal primary particles, the mean particle diameter of these primary particles is preferably from about 5 nm to about 125 nm, most preferably from about 7 nm to about 100 nm. The colloidal primary particles are preferably in the form of an aqueous sol as described above.

Aggregation of primary particles in a sol to form a dispersion of porous aggregates may be performed with any suitable method, such as those described in R. K. Iler, “The Chemistry of Silica” 1979, pages 364-407. The degree of aggregation can be followed by measuring the viscosity and applying the Einstein and Mooney equations (see e.g. R. K. Iler, “The Chemistry of Silica” 1979, pages 360-364). The aggregation may be performed as a separate step or in a mixture also comprising other pigment particles.

In one embodiment, an anionic sol (comprising negatively charged colloidal primary particles) and a cationic sol (comprising positively charged colloidal primary particles) are mixed, resulting in the formation of porous aggregates of primary particles from both the sols.

In another embodiment a salt, preferably selected from divalent, multivalent or complex salts, is added to an anionic or cationic sol also resulting in the formation of porous aggregates. Examples of salts are aluminium chloride, poly aluminium chloride, poly aluminium silicate sulfate, aluminium sulfate, zirconium carbonates, zirconium acetates, alkali metal borates, and mixtures thereof.

In still another embodiment a bridging substance is used to form the aggregates from the primary particles. Examples of suitable bridging substances are synthetic and natural polyelectrolytes such as CMC (carboxymethyl cellulose), PAM (polyacrylamides), polyDADMAC (poly diallyl dimethyl ammoniumchloride), polyallyl amines, polyamines, starch, guar gums, and mixtures thereof.

Any combination including one, two or all three of the above aggregation methods can also be employed.

Each porous aggregate is formed from at least three primary particles, which inherently gives at least some pores. The mean particle diameter of the aggregates is preferably from about 0.03 to about 25 μm, more preferably from about 0.05 to about 10 μm, most preferably from about 0.1 μm to about 5 μm. It is to be understood that the average diameter of the porous aggregates is always larger than the average diameter of the primary particles they are formed from. The surface area of the aggregates is usually essentially the same as of the primary particles.

A water soluble aluminium salt as cationic component in the pigment composition can be any aluminium containing salt and is preferably present in an amount from about 0.1 wt % to about 30 wt % most preferably from about 0.2 wt % to about 15 wt %, calculated as wt % Al₂O₃ on dry pigment particles. Examples of salts include aluminium chloride, poly aluminium chloride, poly aluminium silicate sulfate, aluminium sulfate, zirconium carbonates, zirconium acetates , and mixtures thereof. The aluminium may be present partly or fully on the surface of the particles of silica or aluminosilicate or in the aqueous phase.

The entire content of water soluble aluminium salt may originate from what is present in a cationic aluminium modified silica sol used for preparing the pigment composition, it thus being possible to use a pigment composition consisting essentially of a cationic silica sol as a coating. However, the pigment composition may also comprise additional aluminium salt.

A cationic polymer as cationic component in the pigment composition has a molecular weight from about 2000 to about 1000000, preferably from about 2000 to about 500000, most preferably from about 5000 to about 200000. The charge density is from about 0.2 meq/g to about 12 meq/g, preferably from about 0.3 meq/g to about 10 meq/g, most preferably from about 0.5 meq/g to about 8 meq/g. The cationic polymer is preferably present in the pigment dispersion in an amount from about 0.1 wt % to about 30 wt %, more preferably from about 0.5 wt % to about 20 wt %, most preferably from about 1 wt % to about 15 wt %, based on the amount of dry pigment particles. Examples of suitable cationic polymers include syntetic and natural polyelectrolytes such as PAM (polyacrylamides), polyDADMAC (poly diallyl dimethyl ammoniumchloride), polyallyl amines, polyamines, polysaccharides and mixtures thereof, provided that the molecular weight and charged density fulfil the above requirements. The cationic polymer may be present partly or fully on the surface of the particles of silica or aluminosilicate or in the aqueous phase.

A preferred pigment composition comprises both at least one water soluble aluminium salt as described above and at least one cationic polymer as described above.

In an embodiment the composition further comprises other kinds of pigment particles such as kaolinites, smectites, talcites, calcium carbonate minerals, precipitated calcium carbonate, precipitated silica, gel-type silica, fumed silica, and mixtures thereof. The content of optionally aggregated colloidal particles of silica or aluminosilicate prepared from alkali metal silicate by ion exchange or pH-reduction and having a surface area from about 30 m²/g to about 450 m²/g is preferable from about 10 wt % to 100 wt %, most preferable from about 30 wt % to 100 wt % of the total amount of pigment particles.

The total content of pigment particles of optionally aggregated colloidal silica or aluminosilicate as described above and optional other pigment particles in the composition is preferably from about 1 wt % to about 60 wt %, most preferably from about 5 wt % to about 50 wt %, particularly most preferably from about 10 wt % to about 50 wt %.

The pigment composition may also comprise other additives commonly used for paper coating such as stabilisers, rheology modifiers, optical brighteners, lubricants, insolubilizers, dyes, sizing agents etc, as well as various impurities from the raw materials. The dry content of the pigment composition is preferably from about 2 wt % to about 75 wt %, most preferably from about 10 wt % to about 70 wt %. The total amount of other additives and possible impurities is preferably from 0 to about 50 wt %, most preferably from 0 to about 30 wt %, based on the dry content.

A pigment composition as described above is preferably storage stable for at least one week, most preferably at least one month. The composition may be used directly for coating paper or paperboard or form an intermediate product for preparing a coating composition.

The coating is preferably applied in an amount sufficient to yield from about 0.5 g/m² to about 40 g/m², most preferably from about 1 g/m² to about 20 g/m² of optionally aggregated colloidal particles of silica or aluminosilicate with a surface area from about 30 g/m² to about 450 g/m² and optionally other pigment particles from the pigment composition per coated side of the paper or paper board. In most cases the dry amount of coating applied per coated side of the paper or paper board is preferably from about 0.5 g/m² to about 50 g/m², most preferably from about 1 g/m² to about 25 g/m².

The coating is preferably applied to a non-coated side of the paper or paper board but may also be applied on top of a previously applied coating layer with the same or another coating composition. It is preferred not to apply any further coating of other kind on top of the layer formed from the coating as described herein.

Applying the coating can be performed either on the paper or board machine or off the paper or board machine. In either case any type of coating methods can be used. Examples of coating methods are blade coating, air knife coating, roll coating, curtain coating, spray coating, size press coating (e.g. film press coating) and cast coating.

After applying the coating the paper is dried, which in the case of on machine coating preferably is accomplished in a drying section of the machine. Any means of drying may be used, such as infra red radiation, hot air, heated cylinders or any combination thereof.

The term coating as used herein refers to any method in which pigments are applied to the surface of paper or paper board, thus including not only conventional coating but also other methods such as for example pigmenting.

The paper and paper board to be coated can be made from any kind of pulp, such as chemical pulp like sulfate, sulfite and organosolve pulps, mechanical pulp like thermo-mechanical pulp (TMP), chemo-thermo-mechanical pulp (CTMP), refiner pulp or ground wood pulp, from both hardwood and softwood bleached or unbleached pulp that is based on based on virgin or recycled fibres or any combination thereof. Paper and paper board from any other kind of pulp may also be coated in accordance with the invention.

The invention further concerns paper or paper board suitable for ink-jet printing obtainable by a process as described above. Such paper or paper board comprises a substantially transparent or substantially non-transparent layer comprising pigment particles of synthetic amorphous silica or aluminosilicate and optionally other pigment particles from the coating composition, the pigment particles preferably forming a nano-structure. The dry amount of coating is preferably from about 0.5 g/m² to about 50 g/m², most preferably from about 1.0 g/m² to about 25 g/m². The amount of pigment particles from the above described pigment composition per coated side of the paper or paper board is preferably from about 0.5 g/m² to about 40 g/m², most preferably from about 1 g/m² to about 20 g/m². Preferably no other kind of coating has been applied on top of this layer.

It has been found that the paper or paper board of the invention have particularly good properties for ink-jet printing, giving low line blurriness and mottling and high printing density for colours, but can advantageously also be used for other kinds of printing processes like toner, flexography, letter press, gravure, offset lithography and screen printing. It is a particular advantage that such good properties can be obtained in a simple manner by applying only small amounts of the coating and without the need to apply numerous different coating layers on the paper or paper board. This also enable the coating to be applied with a size press, such as a film press, which for practical reasons is advantageous. Furthermore, the main components of the pigment composition can be made from readily available raw materials.

Some pigment compositions useful for the process of the invention are novel. An aspect of the invention thus also concerns a pigment composition in the form of an aqueous dispersion as pigment particles optionally aggregated colloidal particles of silica or aluminosilicate prepared from alkali metal silicate by ion exchange or pH-reduction and having a surface area from about 30 m²/g to about 450 m²/g, and at least one cationic polymer having a molecular weight from about 2000 to about 1000000 and a charge density from about 0.2 meq/g to about 12 meq/g, said composition being substantially free from or comprising, based on the total amount of pigment particles, less than about 3 wt %, preferably less than about 2 wt %, most preferably less than about 1 wt % of organic coating binders. Preferably the composition also comprises a water soluble aluminium salt. Organic coating binders include polyvinyl alcohols, optionally modified starches, gums, protein binders (e.g. caseins and soy protein binders), latices and mixtures thereof. Latices can, for example, be based on styrene butadien, acrylates, vinyl acetate, co-polymers of ethylene and vinyl acetates, styrene acrylic esters etc.

Regarding suitable and preferred amounts and kinds of the components, the above description of the pigment composition in connection with the process for the production of coated paper or paperboard is referred to.

The invention further relates to a process for the production of a pigment composition as described above comprising mixing a sol of optionally aggregated colloidal particles of silica or aluminosilicate prepared from alkali metal silicate by ion exchange or pH-reduction and having a surface area from about 30 m²/g to about 450 m²/g with a cationic polymer having a molecular weight from about 2000 to about 1000000 and a charge density from about 0.2 meq/g to about 12meq/g and optionally a water soluble aluminium salt to an aqueous dispersion in a way so substantial gelling or precipitation is avoided. This can be achieved by several alternative process embodiments.

One alternative process embodiment comprises a step of adding a sol of colloidal particles of silica or aluminosilicate having a surface area from about 30 m²/g to about 450 m²/g to an aqueous solution of a water soluble aluminium salt, followed by adding a cationic polymer as described above. Other components such as other pigment particles may be added at any stage in the form of solids, liquids or dispersions. The silica or aluminium silicate particles are preferably in the form of an aqueous sol of colloidal particles, that may be anionic or cationic. Unless a cationic sol is used, the aluminium salt is preferably in such an excess that it is sufficient for rendering the resulting dispersion predominantly cationic. At least if an anionic sol is used, there may be at least some aggregation of the colloidal particles.

Another alternative process comprises a step of adding a sol of colloidal particles of silica or aluminosilicate having a surface area from about 30 m²/g to about 450 m²/g to an aqueous solution of a cationic polymer as described above, optionally followed by adding a water soluble aluminium salt. Other components such as other pigment particles may be added at any stage in the form of solids, liquids or dispersions. The silica or aluminium silicate particles are preferably in the form of an aqueous sol of colloidal particles, that may be anionic or cationic. Unless a cationic sol is used, the cationic polymer is preferably in such an excess that it is sufficient for rendering the resulting dispersion predominantly cationic. At least if an anionic sol is used, there may be at least some aggregation of the colloidal particles.

Still another process embodiment comprises a step of mixing a cationic aluminium modified aqueous sol of colloidal silica or aluminosilicate with a cationic polymer. Although possible, it is not necessary to add further water soluble aluminium salt apart from what is present in the sol colloidal silica or aluminosilicate. Other components such as other pigment particles may be added at any stage in the form of solids, liquids or dispersions.

Regarding suitable and preferred amounts and kinds of the components, the above description of the pigment composition is referred to.

The invention will now be further described in following examples. Unless otherwise stated all parts and percentages refer to parts and percent by weight.

### EXAMPLE 1

Three pigment compositions were prepared.
A) Bindzil™ CAT from Eka Chemicals, a silica sol cationised by incorporation of a polyaluminium salt, having a surface area of about 500 m²/g and a concentration of 15 wt % SiO2, used as is in the coating.
B) Bindzil™ CAT 220 from Eka Chemicals, a silica sol cationised by incorporation of a polyaluminium salt, having a surface area of about 220 m²/g and a concentration of 30 wt % SiO2, was diluted to a concentration of 15 wt % SiO2 prior to the coating application.
C) Bindzil™ CAT 80 from Eka Chemicals, a silica sol cationised by incorporation of a polyaluminium salt, having a surface area of about 80 m²/g and a concentration of 40 wt % SiO2, was diluted to a concentration of 15 wt % SiO2 prior to the coating application.

The three pigment compositions were applied on surface of an uncoated copy paper (A4 sized Data Copy from M-real) by a drawdown method with a wired rod as commonly used in laboratory coating tests. No organic coating binder was added. After the coating the paper was dried with an IR-dryer (Hedson Technologies AB, Sweden). The dried sheets of papers were evaluated on three inkjet printers, HP Deskjet™ 5850 from Hewlett-Packard, Epson Stylus™ C86 from Epson and Canon iP 4000.

The print result was evaluated using a print picture with seven colour blocs, cyan, magenta, yellow, red, green, blue and black. The printed blocs and the unprinted paper were measured with a spectrophotometer (Color Touch 2 from Technidyne) and the colour gamut volume was calculated. The gamut volume is approximated with a dodecahedral in the CEI L*a*b* colour space and the measurements of the colours give the corners in the dodecahedral (see “Rydefalk Staffan, Wedin Michael; Litterature review on the colour Gamut in the Printing Process-Fundamentals, PTF-report no 32, May 1997”). The results are shown in the table below:

| | | Gamut | Gamut | Gamut |
|---|---|---|---|---|
| Coating | Coat weight | Volume | Volume | Volume |
| Formulation | g/m2 | HP | Epson | Canon |
| No Coating | — | 166731 | 180995 | 148408 |
| A | 2.9 | 167334 | | |
| A | 2.9 | | 231137 | |
| A | 3.2 | | | 119070 |
| B | 2.5 | 231803 | | |
| B | 2.3 | | 239903 | |
| B | 2.6 | | | 189439 |
| C | 1.2 | 216299 | | |
| C | 1.5 | | 241026 | |
| C | 1.3 | | | 210213 |

It appears that the silica sols B and C with low surface gave a significant higher print quality than silica sol A with high surface area. A visual judgement also revealed that the prints of papers form experiments gave good line sharpness and no tendency of colour mottling.

### EXAMPLE 2

In this example five pigment composition were evaluated.
D) A 15 wt % pigment slurry was prepared by dispersing a kaolin coating clay (SPS™, Imerys, UK) in water by using intensive mixing in an UltraTurrax™.
E) A 15 wt % pigment slurry was prepared by dispersing a gel-type silica, Sylojet™ P612 from Grace Davison in water by using intensive mixing in an UltraTurrax™.
F) 30 g of Bindzil™ 50/80 from Eka Chemicals, an anionic silica sol with a concentration of 50 wt % (SiO2) and a surface area of 80 m²/g, was mixed with 15 g of kaolin coating clay (SPS™) and 55 g water in an UltraTurrax™. Before use the composition was further diluted to 15 wt % pigment concentration.
G) 30 g of Bindzil™ 50/80, 15 g of kaolin coating clay (SPS™) and 31 g water were mixed in an UltraTurrax™ and transferred into a solution containing 6 g of aluminium chlorohydrate (Locron™ from Clariant, 25 wt % Al₂O₃) and 18 g water under vigorous stirring (UltraTurrax™). The resulting composition had a pigment concentration of 30 % and was then further diluted to 15 wt %.
H) 30 g of Bindzil™ 50/80, 15 g of kaolin coating clay (SPS™) and 31 g water were mixed in an UltraTurrax™ and transferred into a solution containing 3 g of polyDADMAC (40 wt %, average molecular weight of about 20 000 and cationic charge density of 7.2 meq/g) and 21 g water under vigorous stirring (UltraTurrax™). The resulting composition had a pigment concentration of 30 wt % and was then further diluted tol 5 wt %.

Following the same procedure as in Example 1, the compositions were applied to paper without any organic coating binder and dried and evaluated on three printers. The results are shown in the table below:

| | | Gamut | Gamut | Gamut |
|---|---|---|---|---|
| Coating | Coat weight | Volume | Volume | Volume |
| Formulation | g/m2 | HP | Epson | Canon |
| D | 1.7 | 132721 | | |
| D | 2.1 | | 192600 | |
| D | 2.3 | | | 146150 |
| E | 1.8 | 259309 | | |
| E | 1.3 | | 246995 | |
| E | 2.0 | | | 230879 |
| F | 2.1 | 168525 | | |
| F | 1.6 | | 199542 | |
| F | 1.9 | | | 162425 |
| G | 1.6 | 189934 | | |
| G | 1.4 | | 224625 | |
| G | 1.8 | | | 192598 |
| H | 1.4 | 197839 | | |
| H | 1.3 | | 218972 | |
| H | 1.7 | | | 143918 |

It can be seen that compositions G and H containing a cationic component gave an over-all better print quality compared to F being a sole blend of silica sol and clay.

Although composition E, being a gel-type silica, gave the highest gamut volume, it was, however, noted that the coated layer on this paper as well as the clay coating in from D were very poorly adhered to the paper surface. This resulted in extensive chalking when touching the coated surfaces with the finger tips. It was therefore evident that these two pigment compositions could not give a paper useful for printing unless combined with a coating binder.

A dusting test on the non printed coated papers were also conducted. A strip of a low-tack tape, 5×15 cm was pressed for 1 minute on the coated paper surface and thereafter removed from the paper. The tape was weighted before and after the contact with the paper surface and the weight difference gives the amount of dust removed from the coated layer.

The papers with coating C (from example 1), D, E and G were tested. The results are shown in the table below:

| Paper sample | Amount of dust, mg |
|---|---|
| C | 0.5 |
| D | 2.0 |
| E | 5.5 |
| G | 0.7 |

The results show that paper produced from compositions C and G had much lower tendency to dust compared to paper with the conventional pigments D and E when no organic binder coating binder was used.

### EXAMPLE 3

In the test an anionic silica sol, Bindzil™ 50/80 from Eka Chemicals was used as pigment, a 50 wt % sol with a mean particle size of 40 nm. Two formulations were prepared without any PVA-binder.
I) Bindzil™ 50/80 diluted to 30 wt %.
J) 6 g Locron™ was diluted with 20 g water and 60 g of Bindzil™ 50/80 was added under vigorous mixing (UltraTurrax™). The mixing continued during the addition of 3 g polyDADMAC (same as in example 1) and 11 g water. The final concentration of silica became 30 wt %.

Following the same procedure as in Example 1, the coatings were applied to paper and dried (coat weight 8-9 g/m²) and evaluated on the Epson and HP-printers. The results are shown in the table below:

| Coating | | |
|---|---|---|
| Formulation | Gamut Volume Epson | Gamut Volume HP |
| I | 262220 | 229017 |
| J | 260601 | 261672 |

It appears that although coating formulation I gave a slightly better gamut volume on Epson, formulation J was significantly better on HP and therefore can be considered as giving best over-all result. A visual judgement also revealed good line sharpness and no tendency of colour mottling.

### EXAMPLE 4

Four coating formulations were prepared. A pigment composition of equal parts (dry/dry) of anionic silica sol, Bindzil™ 50/80 and kaolin a coating clay (SPS™, Imerys, UK) were used in all formulations. As in Example 3 no external binder such as PVA was used in any of the formulations.
K) Bindzil™ 50/80, SPS™ clay and water were mixed in UltraTurrax™ to a pigment concentration of 30 wt %.
L) A pigment slurry containing 15 g Bindzil™ (as dry) and 15 g SPS clay was added to a water solution containing 6 g Locron™ (as is) under UltraTurrax™ mixing and the final pigment concentration became 30 wt %.
M) 3 g polyDADMAC (same as in example 1) was diluted with water and added to a pigment slurry containing 15 g of Bindzil™ (as dry) and 15 g SPS™ clay under Ultra-Turrax™ mixing to a pigment solids of 30 wt %.
N) A pigment slurry was mixed with Locron™ solution as in A. The UltraTurrax mixing continued and 3 g polyDADMAC (same as in Example 1) was diluted with water and added to a Locron treated pigment slurry to obtain a final pigment content of 30 wt %.

Following the same procedure as in Example 3, the coatings were applied to paper and dried (coat weight 8-9 g/m²) and evaluated on two printers. The results are shown in the table below:

| Coating | | |
|---|---|---|
| Formulation | Gamut Volume Epson | Gamut Volume HP |
| No coating | 178288 | 163247 |
| K | 233379 | 177191 |
| L | 253114 | 201548 |
| M | 233987 | 208773 |
| N | 268608 | 211090 |

It appears that the over-all best printing results are obtained with the compositions containing an aluminium salt or/and a low cationic molecular weight polymer ( L, M and N).

1. A process for the production of coated paper or paperboard comprising a step of applying a pigment composition as a coating to at least one side of a paper or paperboard web, said pigment composition being an aqueous dispersion comprising as pigment particles optionally aggregated colloidal particles of silica or aluminosilicate prepared from alkali metal silicate by ion exchange or pH-reduction and having a surface area from about 30 m²/g to about 450 m²/g, and at least one cationic component selected from the group consisting of water soluble aluminium salts and cationic polymers with a molecular weight from about 2000 to about 1000000 and a charge density from about 0.2 meq/g to about 12 meq/g, wherein at least about 0.4 g pigment particles from the pigment composition are applied per m² coated side of the paper or paper board web.

2. Process as claimed in claim 1, wherein the pigment composition applied to the paper or paper board is substantially free from or comprises, based on the total amount of pigment particles, less than about 3 wt % of organic coating binders.

3. Process as claimed in claim 1, wherein the pigment particles of optionally aggregated colloidal particles of silica or aluminosilicate have a mean diameter from about 0.005 μm to about 25 μm.

4. Process as claimed in claim 1, wherein the pigment composition comprises at least one water soluble aluminium salt in an amount from about 0.1 wt % to about 30 wt %, calculated as wt % Al₂O₃ on dry pigment particles.

5. Process as claimed in claim 1, wherein the at least one water soluble aluminium salt is selected from the group consisting of aluminium chloride, poly aluminium chloride, poly aluminium silicate sulfate, aluminium sulfate, zirconium carbonates, zirconium acetates, and mixtures thereof.

6. Process as claimed in claim 1, wherein the pigment composition comprises at least one cationic polymer with a molecular weight from about 2000 to about 1000000 and a charge density from 0.2 meq/g to about 12 meq/g in an amount from about 0.1 wt % to about 30 wt %, based on the amount of dry pigment particles.

7. Process as claimed in claim 1, wherein the at least one cationic polymer is selected from the group consisting of PAM (polyacrylamides), polyDADMAC (poly diallyl dimethyl ammoniumchloride), polyallyl amines, polyamines, polysaccharides and mixtures thereof.

8. Process as claimed in claim 1, wherein the pigment composition comprises at least one water soluble aluminium salt and at least one cationic polymer having a molecular weight from about 2000 to about 1000000 and a charge density from about 0.2 meq/g to about 12 meq/g.

9. Process as claimed in claim 1, wherein the net surface charge of the pigment particles in the composition is positive.

10. Process as claimed in claim 1, wherein the pigment composition further comprises other kinds of pigment particles.

11. Process as claimed in claim 10, wherein the other kinds of pigment particles are selected from the group consisting of kaolinites, smectites, talcites, calcium carbonate minerals, precipitated calcium carbonate, precipitated silica, gel-type silica, fumed silica, and mixtures thereof.

12. A process for the production of coated paper or paperboard comprising a step of applying a pigment composition as a coating to at least one side of a paper or paperboard web, said pigment composition being an aqueous dispersion comprising as pigment particles optionally aggregated colloidal particles of silica or aluminosilicate prepared from alkali metal silicate by ion exchange or pH-reduction and having a surface area from about 30 m²/g to about 450 m²/g, at least one water soluble aluminium salt, and at least one cationic polymer with a molecular weight from about 2000 to about 1000000 and a charge density from about 0.2 meq/g to about 12 meq/g, wherein at least about 0.4 g pigment particles from the pigment composition are applied per m² coated side of the paper or paper board web.

13. Process as claimed in claim 12, wherein the pigment composition applied to the paper or paper board is substantially free from or comprises, based on the total amount of pigment particles, less than about 3 wt % of organic coating binders.

14. Process as claimed in claim 13, wherein the pigment composition further comprises other kinds of pigment particles.

15. Process as claimed in claim 14, wherein the other kinds of pigment particles are selected from the group consisting of kaolinites, smectites, talcites, calcium carbonate minerals, precipitated calcium carbonate, precipitated silica, gel-type silica, fumed silica, and mixtures thereof.

16. Coated paper or paper board produced by a process comprising a step of applying a pigment composition as a coating to at least one side of a paper or paperboard web, said pigment composition being an aqueous dispersion comprising as pigment particles optionally aggregated colloidal particles of silica or aluminosilicate prepared from alkali metal silicate by ion exchange or pH-reduction and having a surface area from about 30 m²/g to about 450 m²/g, and at least one cationic component selected from the group consisting of water soluble aluminium salts and cationic polymers with a molecular weight from about 2000 to about 1000000 and a charge density from about 0.2 meq/g to about 12 meq/g, wherein at least about 0.4 g pigment particles from the pigment composition are applied per m² coated side of the paper or paper board web.

17. A pigment composition in the form of an aqueous dispersion as pigment particles optionally aggregated colloidal particles of silica or aluminosilicate prepared from alkali metal silicate by ion exchange or pH-reduction and having a surface area from about 30 m²/g to about 450 m²/g, and at least one cationic polymer having a molecular weight from about 2000 to about 1000000 and a charge density from about 0.2 meq/g to about 12 meq/g, said composition being substantially free from or comprising, based on the total amount of pigment particles, less than about 3 wt % of organic coating binders.

18. Pigment composition as claimed in claim 17 further comprising at least one water soluble aluminium salt.

19. A process for the production of a pigment composition comprising mixing a sol of optionally aggregated colloidal particles of silica or aluminosilicate prepared from alkali metal silicate by ion exchange or pH-reduction and having a surface area from about 30 m²/g to about 450 m²/g with a cationic polymer having a molecular weight from about 2000 to about 1000000 and a charge density from about 0.2 meq/g to about 12meq/g to an aqueous dispersion in a way so substantial gelling or precipitation is avoided.
